(19) United States
(12) Patent Application Publication
(10) Pub. No.: US 2012/0134525 A1
(43) Pub. Date: May 31, 2012

(54) AUDIO INTERFACE

(75) Inventors: QIANG CHAI, Shenzhen (CN); CHUN-CHIEH TSEN, Tu-Cheng (TW)

(73) Assignees: HON HAI PRECISION INDUSTRY CO., LTD., Tu-Cheng (TW); HONG FU JIN PRECISION INDUSTRY (SHENZHEN) CO., LTD., Shenzhen City (CN)

(21) Appl. No.: 13/089,416

(22) Filed: Apr. 19, 2011

(30) Foreign Application Priority Data
Nov. 29, 2010 (CN) 201020630661.X

(51) Int. Cl. H04R 1/10

(52) U.S. Cl. 381/384

(57) ABSTRACT

An audio interface used for mating with an earphone plug having an electronic conductor is disclosed. The audio interface comprises a socket body; and an insulation wrap protruding from the socket body, the insulation wrap defining a receptacle, the electronic conductor inserted in the receptacle and wholly wrapped by the insulation wrap.

### BACKGROUND

1. Technical Field

The exemplary disclosure generally relates to audio interfaces, particularly to audio interfaces used with electronic devices.

2. Description of Related Art

Electronic devices often provide an audio interface on an outer sidewall of a housing enabling a connection to an earphone plug. However, during insertion/removal of the earphone plug into/out of the audio interface, static electricity may be generated between the audio interface and the earphone plug, which can damage the electronic components, such as circuit board, in the electronic device.

Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the exemplary audio interface. Moreover, in the drawings like reference numerals designate corresponding parts throughout the several views. Wherever possible, the same reference numbers are used throughout the drawings to refer to the same or like elements of an embodiment.

FIG. 1 is a schematic view of an exemplary embodiment of an audio interface.

FIG. 2 is an exploded view of the audio interface of FIG. 1 and an earphone plug mating with the audio interface.

FIG. 3 is a plan view of the insertion of the earphone plug into the audio interface of FIG. 2.

FIG. 4 is a schematic view of another exemplary embodiment of an audio interface.

FIG. 5 is an exploded view of the audio interface of FIG. 4 and an earphone plug mating with the audio interface.

FIG. 6 is a plan view of the insertion of the earphone plug into the audio interface of FIG. 5.

### DETAILED DESCRIPTION

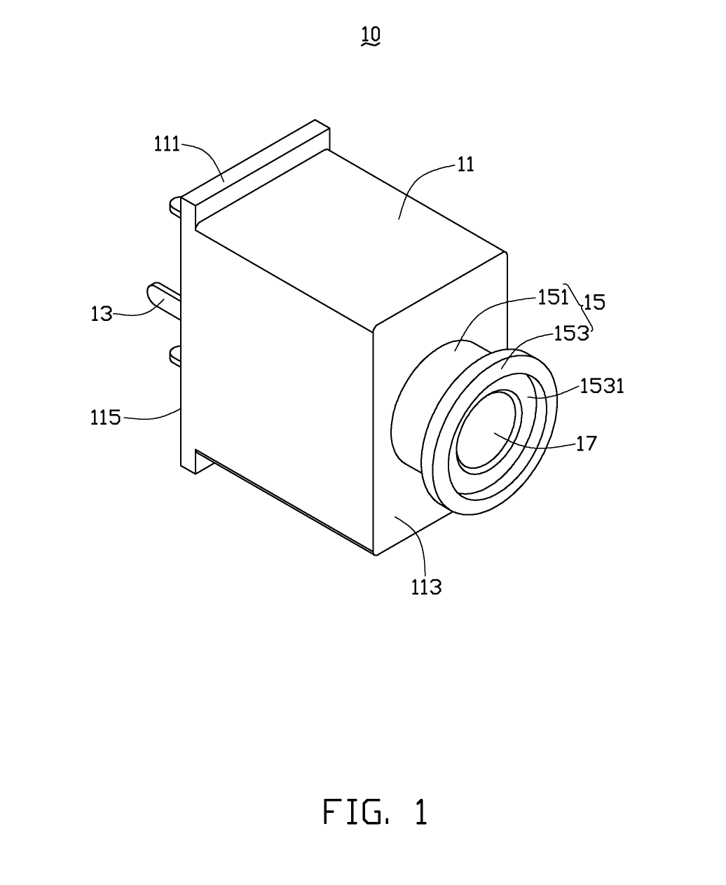

Referring to FIG. 1, an exemplary audio interface 10 includes a socket body 11, at least one contact 13 and an insulation wrap 15. The socket body 11 includes a first surface 113 and an opposite second surface 115. The contact 13 protrudes from the second surface 115, and the insulation wrap 15 protrudes from the first surface 113. The audio interface 10 further includes two positioning blocks 111 respectively protruding from opposite sides of the socket body 11. The positioning blocks 111 position the audio interface 10 with an electronic device using the audio interface 10. The contact 13 is used to electronically connect the audio interface 10 to a circuit board of the electronic device.

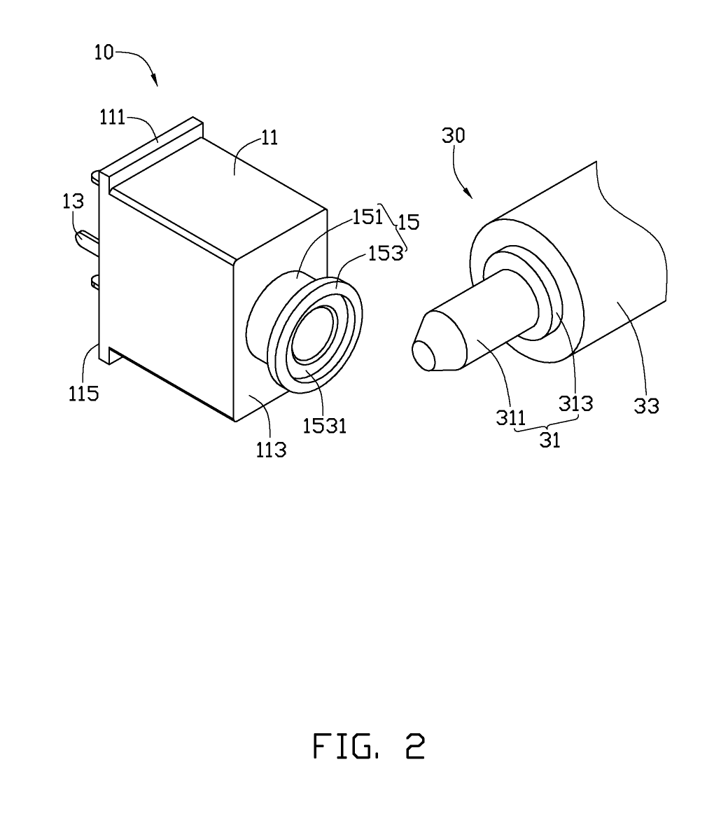

The insulation wrap 15 includes a main body 151 protruding from the first surface 113. The main body 151 defines a receptacle 17, into which an earphone plug 30 (see FIG. 2) can be inserted. The insulation wrap 15 may further include a flange 153 surrounding and coaxially protruding from a distal end of the main body 151. The flange 153 is larger than the main body 151. The flange 153 defines a hole 1531 coaxially communicating with the receptacle 17, the hole 1531 is larger in diameter than the receptacle 17.

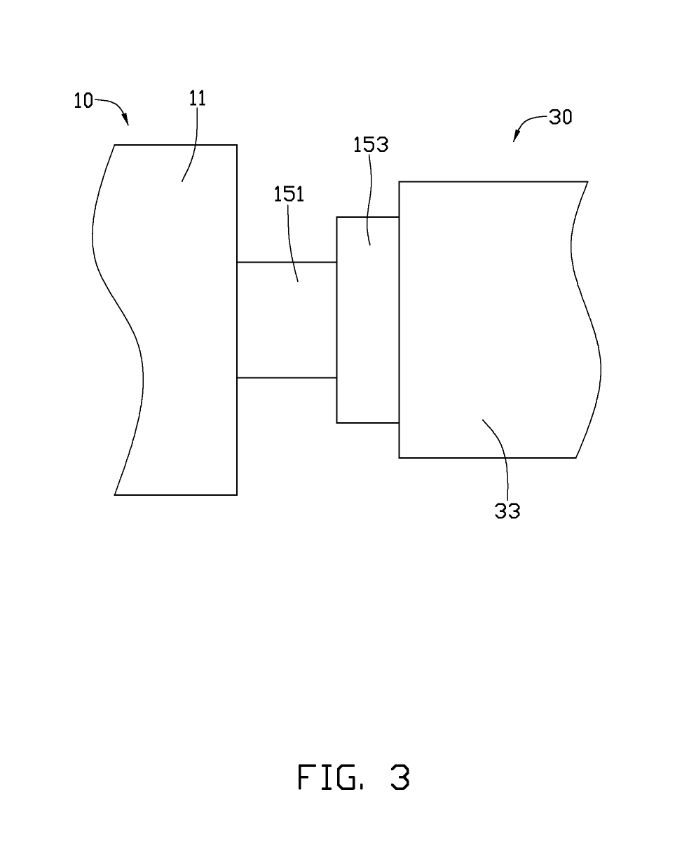

Referring to FIGS. 2 and 3, the earphone plug 30 includes a cable 33 and an electronic conductor 31 extending from the cable 33. The electronic conductor 31 includes a pin 311 and a shoulder 313 surrounding the pin 311 near the cable 33. The shoulder 313 is for strengthening the pin 311. The pin 311 can pass through the receptacle 17 and then electrically connect to the socket body 11. At this time, the pin 311 is received in the receptacle 17, the shoulder 313 is received in the hole 153. Thus, the pin 311 and the shoulder 313 are both wholly wrapped by the insulation wrap 15 to prevent static electricity generated by the user or environmental air from discharging to the electronic conductor 31. As a result, the static electricity from the user or from the environment is prevented from discharging to the audio interface 10.

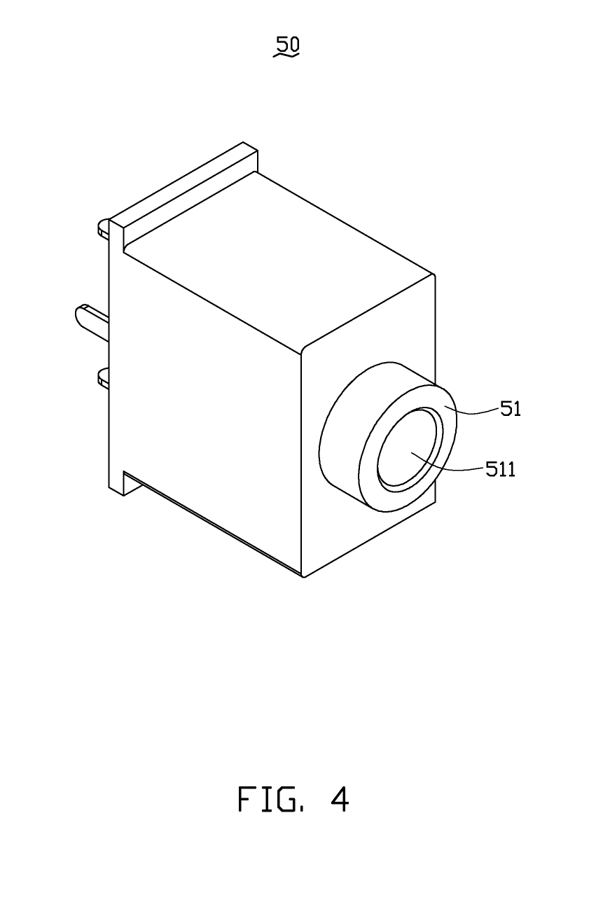

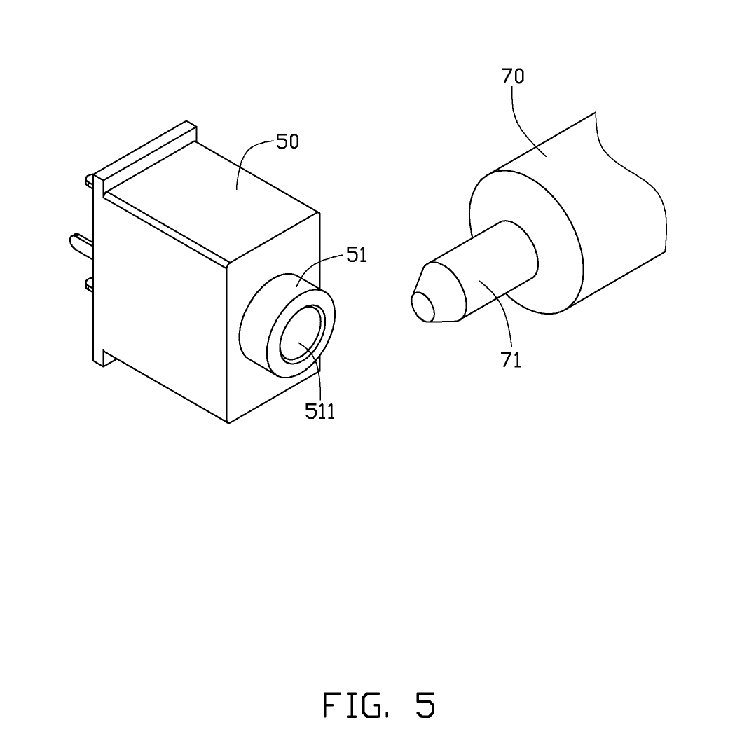

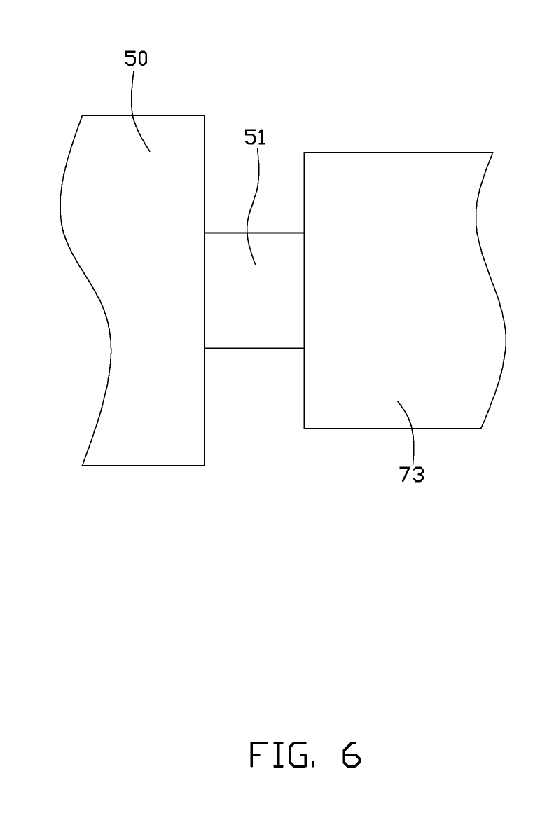

Referring to FIGS. 4 to 6, another exemplary embodiment of an audio interface 50 and an earphone plug 70 mating with the audio interface 50 is disclosed. The audio interface 50 is similar to audio interface 10, but an insulation wrap of the audio interface 50 only includes a main body 51. The audio interface 50 defines a receptacle 511 defined through the insulation wrap 51. The earphone plug 70 is similar to the earphone plug 30, but an electronic conductor of the earphone plug 70 only includes a pin 71. To use the earphone plug 70, the pin 71 is accommodated in the receptacle 511 and wholly wrapped by the main body 51. Which prevents static electricity generated by the user or environmental air from discharging to the pin 71. As a result, static electricity is prevented from discharging to the audio interface 50.

It is to be understood, however, that even through numerous characteristics and advantages of the exemplary disclosure have been set forth in the foregoing description, together with details of the system and function of the disclosure, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. An audio interface used for mating with an earphone plug having an electronic conductor, the audio interface comprising:
a socket body; and
an insulation wrap protruding from the socket body, the insulation wrap defining a receptacle, the electronic conductor inserted in the receptacle and wholly wrapped by the insulation wrap.

2. The audio interface of claim 1, wherein the insulation wrap comprises a main body protruding from the socket body, the receptacle defined through the main body; the electronic conductor comprises a pin; the pin is received in the receptacle and wholly wrapped by the main body.

3. The audio interface of claim 2, wherein the insulation wrap further comprises a flange located at a distal end of the main body; the flange is larger than the main body and defines a hole communicating with and larger in diameter than the receptacle; the electronic conductor further comprises a shoulder surrounding the pin, the shoulder is received in the hole and wholly wrapped by the flange.

4. The audio interface of claim 3, wherein the shoulder strengthens the pin.

5. The audio interface of claim 1, further comprising at least one contact protruding from the socket body, the contact is used to electronically connect the audio interface to a circuit board of the electronic device.

6. The audio interface of claim 1, further comprising two positioning blocks respectively protruding from opposite sides of the socket body; the positioning blocks position the audio interface to an electronic device using the audio interface.

7. An audio interface used for mating with an earphone plug having an electronic conductor, the audio interface comprising:
a socket body; and
an insulation wrap protruding from the socket body, the insulation wrap defining a receptacle, the electronic conductor wholly inserted in the receptacle to prevent static electricity from discharging to the audio interface.

8. The audio interface of claim 7, wherein the insulation wrap comprises a main body protruding from the socket body, the receptacle is defined through the main body; the electronic conductor comprises a pin; the pin is received in the receptacle and wholly wrapped by the main body.

9. The audio interface of claim 8, wherein the insulation wrap further comprises a flange located at a distal end of the main body; the flange is larger than the main body and defines a hole communicating with and larger in diameter than the receptacle; the electronic conductor further comprises a shoulder surrounding the pin, the shoulder is received in the hole and wholly wrapped by the flange.

10. The audio interface of claim 9, wherein the shoulder is for strengthening the pin.

11. The audio interface of claim 7 further comprising at least one contact protruding from the socket body, the contact is used to electronically connect the audio interface to a circuit board of the electronic device.

12. The audio interface of claim 7, further comprising two positioning blocks respectively protruding from opposite sides of the socket body; the positioning blocks position the audio interface to an electronic device using the audio interface.
